(19) United States
(12) Patent Application Publication
(10) Pub. No.: US 2010/0248043 A1
(43) Pub. Date: Sep. 30, 2010

(54) Hydrogen Fuel Cell Water Knock Out Device and Method of Use

(75) Inventors: Casey C. Turner, San Diego, CA (US); Joseph A. Arseneault, Murrieta, CA (US)

Correspondence Address: PROCOPIO, CORY, HARGREAVES & SAVITCH LLP, 525 B STREET, SUITE 2200, SAN DIEGO, CA, 92101, US

(73) Assignee: ISE CORPORATION, Poway, CA (US)

(21) Appl. No.: 12/415,855

(22) Filed: Mar. 31, 2009

(51) Int. Cl. H01M 8/04

(52) U.S. Cl. 429/410; 429/428

(57) ABSTRACT

A hydrogen fuel cell water knockout device for an exhaust system of a heavy duty hybrid hydrogen fuel cell transit bus includes an expansion chamber housing forming an expansion chamber, the expansion chamber including a substantially vertical exhaust section and an exhaust flow path there through with a vertically lowest point in the exhaust flow path; a drain; and a condenser disposed at the vertically lowest point in exhaust flow path of the substantially vertical exhaust section in the expansion chamber so that the condenser condenses water from H₂O exhaust without reintroduction of the water into the exhaust flow path and the water drains from the hydrogen fuel cell water knockout device through the drain.

### FIELD OF THE INVENTION

The field of the invention generally relates to fuel cell hybrid bus exhaust systems of heavy duty vehicles.

### BACKGROUND OF THE INVENTION

Fuel cell technology is the only option to provide zero emission solutions to power vehicles with acceptable ranges for transit demands. In particular, a hydrogen fuel cell will combine pressurized hydrogen and oxygen to produce electricity and exhaust water vapor.

A unique problem occurs with heavy duty hybrid-electric hydrogen fuel cell vehicles. Heavy duty vehicles have vertical exhaust pipes that expel exhaust overhead (See FIGS. 1, 2). Also, in order to optimize efficiency, hybrid electric vehicles may include idle-stop algorithms, where the engine (or fuel cell) will shut down when the energy demand can be satisfied through the vehicle energy storage. In the case of a fuel cell, when the idle stop occurs, significant quantities of water may condense in the exhaust pipe. Then, upon fuel cell restart, a burst of pressure in the exhaust pipe causes condensed liquid water in the exhaust pipe to be expelled out of the exhaust pipe, overhead. This expelled water can alarm and/or spray nearby pedestrians. This may occur often and unexpectedly during a vehicle duty cycle.

### SUMMARY OF THE INVENTION

An aspect of the invention involves an exhaust system for a hydrogen fuel cell vehicle, particularly a heavy duty hydrogen fuel cell vehicle. A water separation device such as a condenser in the exhaust stream of the exhaust system removes water (i.e., liquid). Exhaust flow passes over multiple condensation plates (“plate pack”), and the water that condenses on the plates or is otherwise separated from the exhaust stream is then drained from the exhaust path. Preferably, the condensation plates are positioned at the lowest point of the exhaust path so that the condensed water is not reintroduced into the exhaust flow/path. Since the fuel cell exhaust is a steady stream of lower pressure water vapor, noise escaping through the drain is not a concern.

According to one implementation of the above aspect of the invention, the plate pack is located in an expansion chamber such that pressure, speed, and/or temperature may drop and condensation may increase.

According to another implementation of the above aspect of the invention, the plate pack may include a number of parallel corrugated plates to improve liquid water separation.

According to a further implementation of the above aspect of the invention, the expansion chamber/plate pack/drain may form a single unit, having in and out interfaces with the exhaust system, wherein the single unit replaces a corresponding section of the exhaust ducting.

Another aspect of the invention involves an exhaust system of a heavy duty hybrid hydrogen fuel cell transit bus where the heavy duty hybrid hydrogen fuel cell transit bus includes a hydrogen fuel cell supplying power in the heavy duty hybrid hydrogen fuel cell transit bus, and the hydrogen fuel cell includes a hydrogen fuel cell exhaust outlet that H₂O exhaust from the hydrogen fuel cell is expelled from. The exhaust system includes a substantially vertical exhaust section including an exhaust flow path there through and a vertically lowest point in exhaust flow path; and a hydrogen fuel cell water knockout device disposed in the substantially vertical exhaust section, the hydrogen fuel cell water knockout device including a drain and condenser disposed at the vertically lowest point in exhaust flow path so that the condenser condenses water from the H₂O exhaust without reintroduction of the water into the exhaust flow path and the water drains from the exhaust system through the drain.

A further aspect of the invention involves a hydrogen fuel cell water knockout device for an exhaust system of a heavy duty hybrid hydrogen fuel cell transit bus where the heavy duty hybrid hydrogen fuel cell transit bus includes a hydrogen fuel cell supplying power in the heavy duty hybrid hydrogen fuel cell transit bus. The hydrogen fuel cell water knockout device includes an expansion chamber housing forming an expansion chamber, the expansion chamber including a substantially vertical exhaust section and an exhaust flow path there through with a vertically lowest point in the exhaust flow path; a drain; and a condenser disposed at the vertically lowest point in exhaust flow path of the substantially vertical exhaust section in the expansion chamber so that the condenser condenses water from the H₂O exhaust without reintroduction of the water into the exhaust flow path and the water drains from the hydrogen fuel cell water knockout device through the drain.

A still further aspect of the invention involves a method of using a hydrogen fuel cell water knockout device including providing the hydrogen fuel cell water knockout device described immediately above; dropping at least one of pressure, speed, and temperature of the H₂O exhaust drop as the H₂O exhaust passes into the expansion chamber to increase condensation by the condenser; condensing water from the H₂O exhaust using the condenser; and draining the condensed water from the hydrogen fuel cell water knockout device through the drain.

An additional aspect of the invention involves a method of incorporating a hydrogen fuel cell water knockout device into an existing exhaust system of a heavy duty hybrid hydrogen fuel cell transit bus where the heavy duty hybrid hydrogen fuel cell transit bus includes a hydrogen fuel cell supplying power in the heavy duty hybrid hydrogen fuel cell transit bus, the existing exhaust system including one or more sections of exhaust ducting. The method includes removing one or more sections of exhaust ducting of the one or more sections of exhaust ducting; replacing the one or more sections of removed exhaust ducting with the hydrogen fuel cell water knockout device described immediately above; attaching the hydrogen fuel cell water knockout device described immediately above with the remaining, non-removed one or more sections of exhaust ducting.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a perspective view of an embodiment of a heavy duty transit bus, which is an exemplary application for the present invention.

FIG. 2 is enlarged perspective view of an upper rear portion of the heavy duty transit bus, and shows where the exhaust outlets of an embodiment of an exhaust system may be located.

FIG. 3 is schematic of an embodiment of an exhaust system including a hydrogen fuel cell water knock out device in accordance with an embodiment of the present invention.

FIG. 4 is a perspective view of an embodiment of a hydrogen fuel cell water knock out device of the exhaust system.

FIG. 5A is an exploded perspective view of the hydrogen fuel cell water knock out device illustrated in FIG. 4.

FIG. 5B is a perspective view of the hydrogen fuel cell water knock out device illustrated in FIG. 4.

FIG. 6A is a perspective view of an embodiment of a condenser that may be used in the hydrogen fuel cell water knock out device of the exhaust system;

FIG. 6B is a perspective view of an embodiment of an assembly of parallel corrugated plates of the condenser illustrated in FIG. 6A;

FIG. 7 is a simplified sectional view of a pair of parallel corrugated plates of the condenser illustrated in FIG. 6A, and shows the exhaust flow path between the pair of parallel corrugated plates.

### DETAILED DESCRIPTION OF THE INVENTION

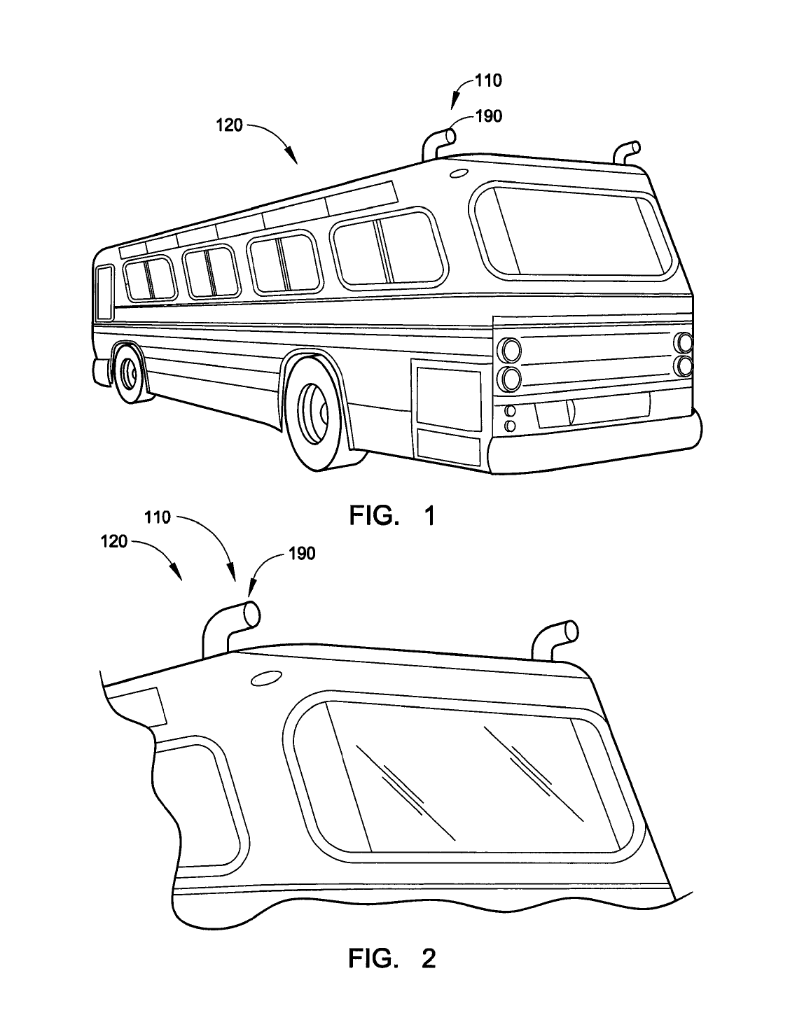

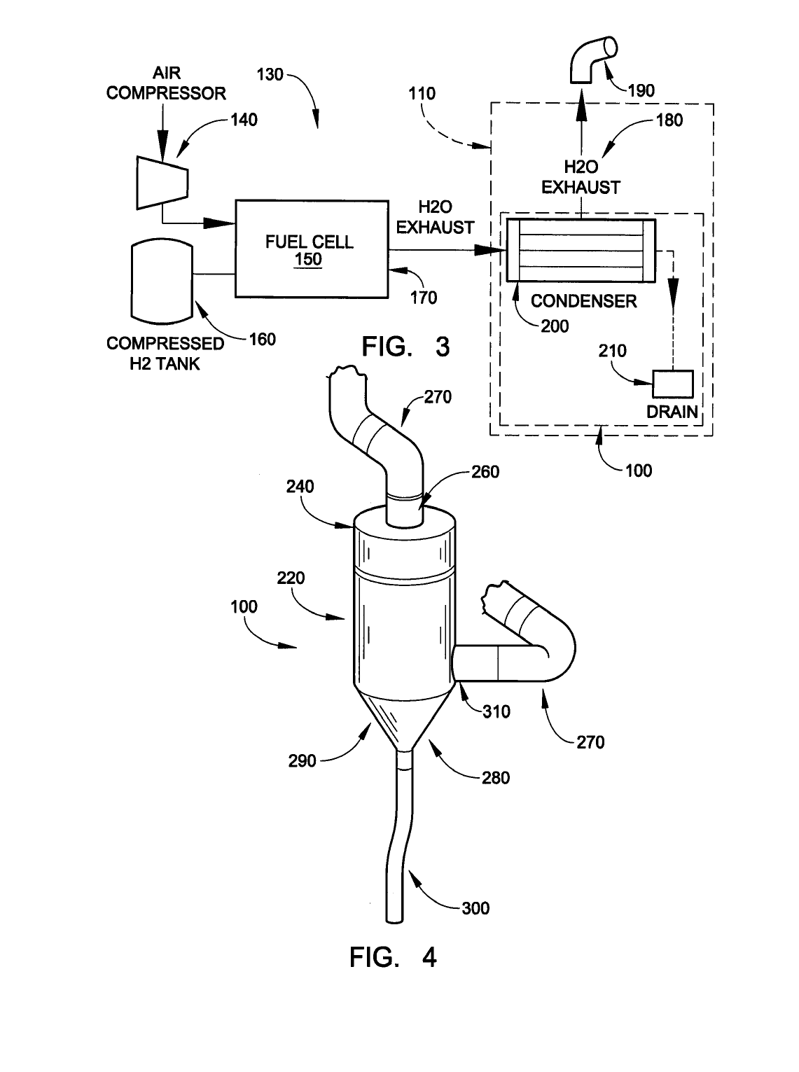

With reference to FIGS. 3-7, a hydrogen fuel cell water knockout device (“device”) 100 constructed in accordance with an embodiment of the invention will be described. The device 100 is part of an exhaust system 110 of a heavy duty hybrid hydrogen fuel cell vehicle (e.g. transit bus) 120 (FIGS. 1, 2). As used herein, a heavy duty vehicle is defined as having a gross weight of over 8,500 lbs. A heavy-duty hybrid vehicle (e.g., heavy duty hybrid hydrogen fuel cell vehicle) will typically have a gross weight of over 10,000 lbs. and may include vehicles such as a metropolitan transit bus, a refuse collection truck, a semi tractor trailer, etc. Although the hydrogen fuel cell water knock out device 100 is described and shown in conjunction with a heavy duty hybrid hydrogen fuel cell metropolitan transit bus, in alternative embodiments, other heavy duty hybrid hydrogen fuel cell vehicles may be used.

With reference to FIG. 3, the hydrogen fuel cell water knock out device 100 will be generally described in relation to an overall hydrogen fuel cell system 130 of the heavy duty hybrid-electric hydrogen fuel cell vehicle 120. The hydrogen fuel cell system 130 includes an air compressor 140 that delivers air under pressure to a hydrogen fuel cell (e.g., one or more hydrogen fuel cells or stacks of hydrogen fuel cells) 150. Pressurized hydrogen gas is supplied to the hydrogen fuel cell 150 by a compressed H₂ tank 160. The hydrogen fuel cell 150 combines the pressurized hydrogen and oxygen to produce electricity and exhaust water vapor (See H₂O exhaust at outlet 170 of hydrogen fuel cell 150). The H₂O exhaust is expelled from the hydrogen fuel cell system 130 through the exhaust system 110, which includes vertical exhaust section 180 and an exhaust outlet 190 (FIGS. 1, 2, 3). It should be noted that the exhaust outlet 190 for the exhaust system 110 is at a higher vertical altitude/height than the hydrogen fuel cell outlet 170.

The vertical exhaust section 180 is a substantially elongated vertical section that is outside of and separate from the hydrogen fuel cell 150/hydrogen fuel cell outlet 170. It is understood, however, that the vertical exhaust section 180 may include various bends in order to be routed within the vehicle as required. The device 100 generally includes a separator/condenser/coalescer (“condenser”) 200 and a drain 210, as well as an exhaust inlet and an exhaust outlet.

The condenser 200 removes water from the exhaust system 110. This may be through a variety of mechanisms (e.g., condensation, mechanical separation, coalescence, filtration, etc.). It is understood that use of the term “condenser” is used in a general sense herein to facilitate understanding of the concept, rather than as a limitation to one particular mechanism for knocking out water from the exhaust. Water (i.e. liquid) in the H₂O exhaust condenses, or is otherwise “knocked out” of the exhaust, in the condenser 200 and is drained from the exhaust path of the exhaust system 110 through the drain 210. Preferably, the condenser 200 is positioned at the lowest available point of the exhaust path so that the condensed water is not reintroduced into the exhaust flow/path. Since the hydrogen fuel cell exhaust is a steady stream of lower pressure water vapor, noise escaping through the drain 210 is not a concern.

With reference to FIGS. 4-7, an exemplary embodiment of the device 100 will be described. It will be readily apparent to those skilled in the art that in alternative embodiments, the device 100 may have alternative configurations and/or constructions. This is particularly true as ducting/routing requirements of the vehicle may vary significantly from vehicle to vehicle, away from the ideal vertical configuration discussed herein. It should be noted that departure from a substantially vertical orientation may result in increased head loss and back pressure at the fuel cell exhaust outlet, which should be minimized.

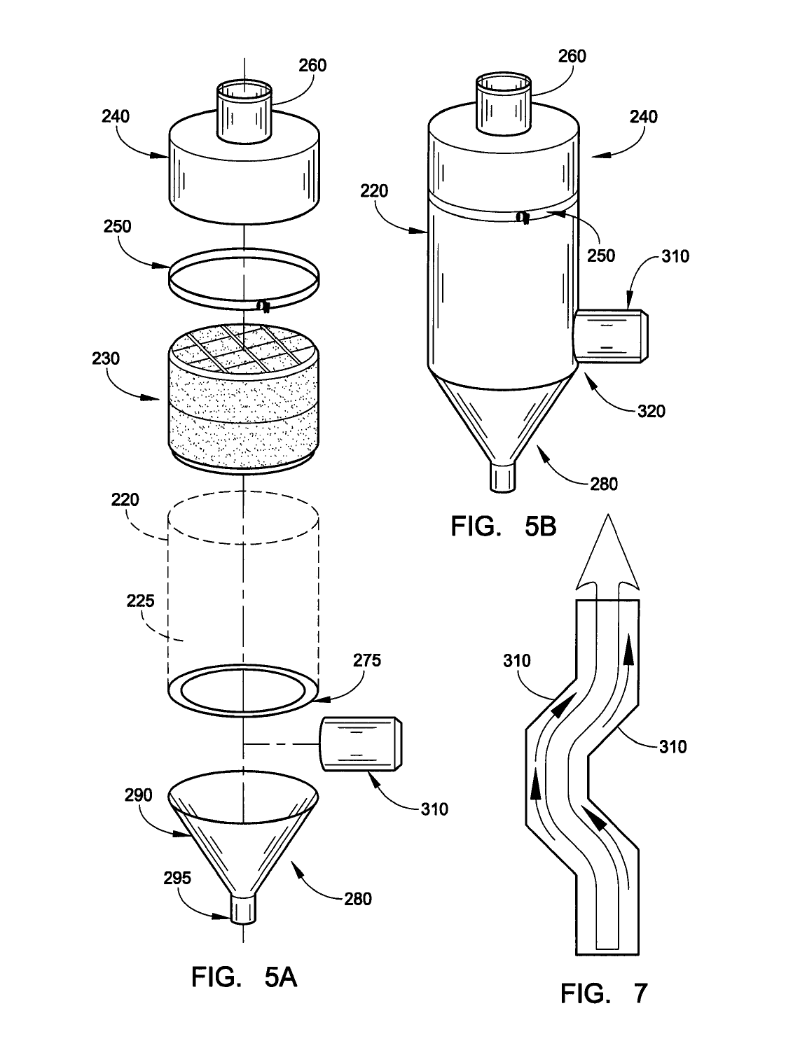

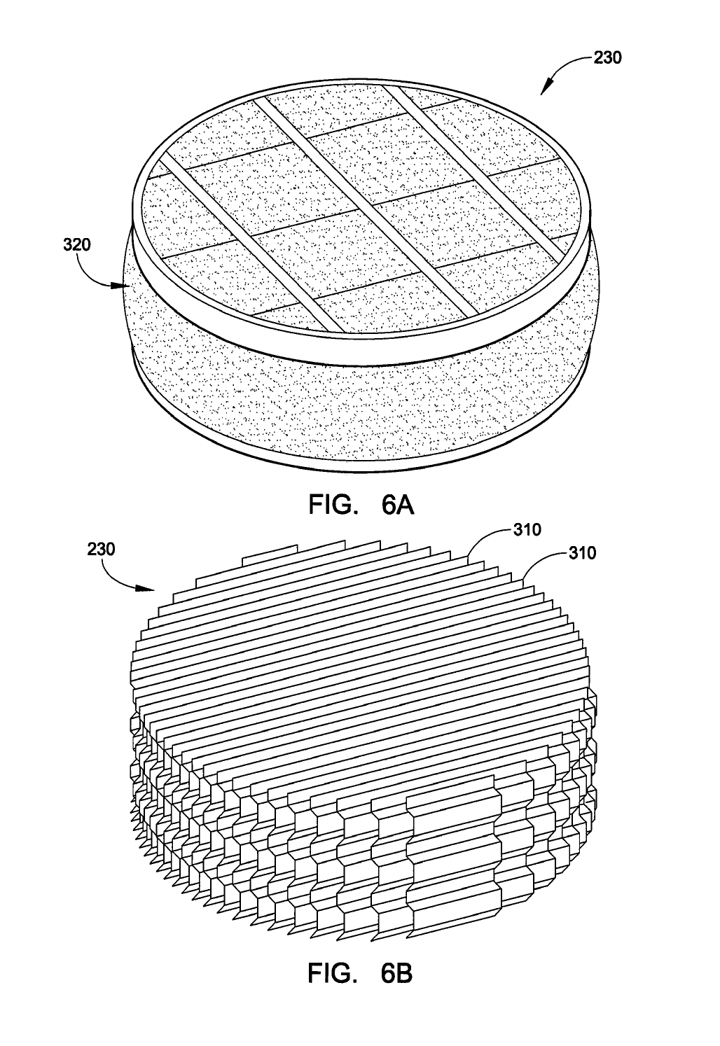

As illustrated, the device 100 includes a cylindrical expansion chamber housing 220 that houses (in an expansion chamber 225) a multiple condensation plate pack 230 (FIGS. 5A, 6A, 6B), which functions as condenser or water and mist eliminator. This cylindrical configuration is preferable, as it is easy and inexpensive to fabricate. In alternate embodiments, the expansion chamber/housing 225, 220 may take a different geometry than illustrated, for example to reduce flow losses, to comply with manufacturability limitations, etc.

Here, also as illustrated, a cylindrical expansion chamber top 240 is attached to a top of the expansion chamber housing 220 via a fastening band 250. Advantageously, this provides for easy access to and maintenance of its internal components. The expansion chamber top 240 includes a cylindrical outlet interface 260, which exhaust path ducting 270 (FIG. 4) is attached to for expelling clean hydrogen fuel cell exhaust (with water removed) from the exhaust system 110 to the atmosphere. Note, ducting 270 is only partially illustrated, and represents generic exhaust ducting that mechanically couples water knock out device 100 to exhaust outlet 190. It is preferably substantially vertical; however, as discussed above, it may be routed in the vehicle as required. As illustrated, an annular seal support 275 may be used to support the plate pack 230 and limit circumferential leakage.

A drain 280, for example, in the form of a drain funnel 290 with cylindrical drain outlet 295, is attached to a bottom of the expansion chamber housing 220. It is understood that drain 280 may take a variety of conveniently selected form factors, only requiring to provide an outlet for separated water to leave the vehicle. As illustrated, downwardly extending vertical drain ducting 310 (FIG. 4) attaches to the cylindrical drain outlet 295 for draining water from the device 100. According to one alternate embodiment, rather than continuously draining the separated water a water catch or basin (not shown) may be used to collect the “knocked out” water. The basin may include a level sensor configured such that, when the water reaches the sensor, a valve opens and allows the water to drain out the basin.

An exhaust inlet interface 310 coupled to the hydrogen fuel cell exhaust outlet 170 connects to and communicates with the expansion chamber housing 220. It should be noted that the exhaust flow path cross section of the expansion chamber housing 220 is significantly larger than that of the inlet interface 310. Exhaust path ducting 270 (FIG. 4) attaches to inlet interface 310 for communicating H₂O exhaust from the outlet 170 of the hydrogen fuel cell 150 to the expansion chamber 225 of the device 100. As discussed above, ducting 270 is only partially illustrated, and represents generic exhaust ducting that mechanically couples water knock out device exhaust inlet interface 310 to the hydrogen fuel cell 150. Ducting 270 preferably is minimalized, with the water knock out device 100 being located as low as practical within the exhaust system 110, however, as discussed above, ducting 270 may be routed within the vehicle as required for placement of the water knock out device 100.

In an implementation of the above embodiment of the device 100, the plate pack 230 is located in the expansion chamber 225 such that pressure, speed, and/or temperature of the H₂O exhaust drop as the H₂O exhaust passes through the device 100 in the exhaust system 110, causing condensation/water separation to increase.

With reference to FIGS. 6A and 6B, in the embodiment of the condenser shown, the plate pack 230 includes a number of parallel corrugated metal plates 310 (FIG. 6B) to improve liquid water separation. Preferably plates 310 are made stainless steel, but they can be made from other metals as well. As shown in FIG. 6A, the plate pack 230 includes a mesh screen 320 surrounding the parallel corrugated plates 310 to help the plate pack fit snuggly into the housing. One example of a commercially available plate pack is a PlatePak vane mist eliminator manufactured by ACS Industries, LP of Houston, Tex. It is understood that this example is not limiting and other geometries, vane configurations, and/or manufacturers may be used.

FIG. 7 is a simplified sectional view of a pair of the parallel corrugated plates 310 of the plate pack 230 illustrated in FIG. 6A, and shows the serpentine exhaust flow path of the H₂O exhaust upward between the pair of parallel corrugated plates 310. As the H₂O exhaust flows upward and through the tortuous paths between the parallel corrugated plates 310, water is captures along the surface of the plates 310 and drains down the plates 310 into the drain 280, where the water drains down and out of the exhaust system 110.

In the embodiment of the device 100 shown in FIGS. 4, 5A, and 5B, the device 100 (e.g., expansion chamber/plate pack/drain) forms a single unit, having in and out interfaces 310, 260 within the exhaust system 110. In a method of adding or incorporating the device 100 into an existing exhaust system 110 (akin to a retrofit), a corresponding section of the exhaust ducting 270 is removed and the single-unit device 100 replaces this corresponding section of the exhaust ducting 270 (in and out interfaces 310, 260 are connected to exhaust ducting 270 as shown). The retrofit may require exhaust ducting 270 to include additional sections and bends to accommodate placement of device 100 within the vehicle and mating the exhaust system 110 with in and out interfaces 310, 260.

With reference to FIGS. 1-7, a method of using the device 100 will now be described. The air compressor 140 delivers air under pressure to the hydrogen fuel cell 150 and pressurized hydrogen gas is supplied to the hydrogen fuel cell 150 by the compressed H₂ tank 160. The hydrogen fuel cell 150 combines the pressurized hydrogen and oxygen to produce electricity and exhaust water vapor (H₂O Exhaust) at the outlet 170 of hydrogen fuel cell 150. The H₂O exhaust is expelled from the hydrogen fuel cell system 130 through the exhaust system 110. The device 100, which is located in the vertical exhaust section 180, removes water from the H₂O exhaust and drains the water from the exhaust system 110 to prevent the problems described above with significant quantities of water condensing (and not draining) in the exhaust pipe. The H₂O exhaust flow passes over the multiple condensation plates 310 of the plate pack 230, and the water that condenses on the plates 310 is then drained from the exhaust path through the drain 280 and drain ducting 300. The plate pack 230 is located in the expansion chamber 225 such that pressure, speed, and/or temperature of the H₂O exhaust drop as the H₂O exhaust passes through the device 100 in the exhaust system 110, causing condensation to increase. Because the condensation plates 310 are positioned at a lowest point 320 (FIG. 5B) of the exhaust path, the condensed water is not reintroduced into the exhaust flow/path. Since the hydrogen fuel cell exhaust is a steady stream of lower pressure water vapor, noise escaping through the drain 280 is not a concern.

The device 100 and methods described herein are advantageous because they are easy to implement into existing exhaust systems of heavy duty hybrid hydrogen fuel cell vehicles (e.g. transit buses) 120, the device 100 and methods perform well in these environments and require minimum maintenance, and the device 100 and methods are low-cost means/methods for preventing the problems described above with significant quantities of water condensing (and not draining) in the exhaust pipe. One particular benefit of the illustrated configuration and method is that device 100 provides a means of knocking out the water while inherently having a low pressure drop across the device. This low pressure drop feature is advantageous in that the fuel cell is not affected by any further back pressure that might be imposed on the system. Fuel Cells can be sensitive to back pressure. Device 100 produces a back pressure of less than 40 mbar at the highest exhaust flows of the system.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An exhaust system of a heavy duty hybrid-electric vehicle, the heavy duty hybrid-electric vehicle powered by a hydrogen fuel cell, the hydrogen fuel cell including a hydrogen fuel cell exhaust outlet that H₂O exhaust from the hydrogen fuel cell is expelled from, the exhaust system comprising:
an exhaust inlet coupled to the hydrogen fuel cell exhaust outlet, and configured to receive H₂O exhaust from the hydrogen fuel cell;
an exhaust outlet located vertically higher than the exhaust inlet, and configured to expel H₂O exhaust from the heavy duty hybrid-electric vehicle;
a water separation device mechanically coupled to the exhaust inlet and the exhaust outlet, and configured to separate water from H₂O exhaust; and
a drain coupled to the water separation device, and configured to provide a path for the separated water to leave the heavy duty hybrid-electric vehicle.

2. The exhaust system of claim 1, wherein the water separation device includes an expansion chamber configured such that at least one of pressure, speed, and temperature of the H₂O exhaust drop while the H₂O exhaust is in the water separation device.

3. The exhaust system of claim 1, wherein the water separation device comprises an external housing and a plurality of parallel plates, and is configured to pass the H₂O exhaust between the plurality of parallel plates.

4. The exhaust system of claim 3, wherein the plurality of parallel plates comprises a plurality of parallel corrugated plates.

5. The exhaust system of claim 1, wherein the water separation device comprises a vane mist eliminator.

6. The exhaust system of claim 1, wherein the heavy duty hybrid-electric vehicle comprises a metropolitan transit bus.

7. The exhaust system of claim 1, wherein the hydrogen fuel cell is controlled by an idle-stop algorithm.

8. The exhaust system of claim 1, wherein the water separation device includes an integrated, single-unit device with an inlet interface and an outlet interface to interface with a remainder of the exhaust system.

9. The exhaust system of claim 1, wherein the water separation device is located in substantially the lowest portion of the exhaust system and the water separation device is coupled to the exhaust outlet via a substantially vertical exhaust section.

10. A hydrogen fuel cell water knockout device for an exhaust system of a heavy duty hybrid hydrogen fuel cell transit bus, the heavy duty hybrid hydrogen fuel cell transit bus including a hydrogen fuel cell supplying power in the heavy duty hybrid hydrogen fuel cell transit bus, comprising:
an expansion chamber housing forming an expansion chamber, the expansion chamber including a substantially vertical exhaust section and an exhaust flow path there through with a vertically lowest point in the exhaust flow path;
a drain;
a condenser disposed at the vertically lowest point in exhaust flow path of the substantially vertical exhaust section in the expansion chamber so that the condenser condenses water from the H₂O exhaust without reintroduction of the water into the exhaust flow path and the water drains from the hydrogen fuel cell water knockout device through the drain.

11. The exhaust system of claim 10, wherein the condenser is a multiple condensation plate pack.

12. The exhaust system of claim 11, wherein the multiple condensation plate pack includes a plurality of parallel corrugated plates to improve liquid water separation.

13. The exhaust system of claim 10, wherein the hydrogen fuel cell water knockout device includes an integrated, single-unit device with an inlet interface and an outlet interface to interface with a remainder of the exhaust system.

14. A method of using a hydrogen fuel cell water knockout device, comprising:
providing the hydrogen fuel cell water knockout device of claim 10;
dropping at least one of pressure, speed, and temperature of the H₂O exhaust drop as the H₂O exhaust passes into the expansion chamber to increase condensation by the condenser;
condensing water from the H₂O exhaust using the condenser;
draining the condensed water from the hydrogen fuel cell water knockout device through the drain.

15. A method of incorporating a hydrogen fuel cell water knockout device into an existing exhaust system of a heavy duty hybrid hydrogen fuel cell transit bus, the heavy duty hybrid hydrogen fuel cell transit bus including a hydrogen fuel cell supplying power in the heavy duty hybrid hydrogen fuel cell transit bus, the existing exhaust system including one or more sections of exhaust ducting, comprising:
removing one or more sections of exhaust ducting of the one or more sections of exhaust ducting;
replacing the one or more sections of removed exhaust ducting with the hydrogen fuel cell water knockout device of claim 10;
attaching the hydrogen fuel cell water knockout device of claim 10 with the remaining, non-removed one or more sections of exhaust ducting.
